(19) United States
(12) Patent Application Publication
(10) Pub. No.: US 2025/0198302 A1
(43) Pub. Date: Jun. 19, 2025

(54) TURBINE-POWERED SYSTEM WITH THERMOELECTRIC COOLING

(71) Applicants: Rolls-Royce Corporation, Indianapolis, IN (US); Rolls-Royce North American Technologies Inc., Indianapolis, IN (US)

(72) Inventors: Jonathan M. Rivers, Indianapolis, IN (US); Robert W. Heeter, Indianapolis, IN (US); Daniel E. Molnar, Jr., Indianapolis, IN (US)

(21) Appl. No.: 18/541,974

(22) Filed: Dec. 15, 2023

(51) Int. Cl. F01D 25/12

(52) U.S. Cl. CPC F01D 25/12; F05D 2220/36; F05D 2260/96

(57) ABSTRACT

The present disclosure teaches a turbine-powered system with a thermoelectric cooler configured to selectively cool powered electronics in the system. In examples provided, the thermoelectric cooler including a cooling plate coupled to the powered electronics and a heat sink integrated into aero surfaces of a gas turbine engine.

### FIELD OF THE DISCLOSURE

The present disclosure relates generally to turbine-powered systems such as aircraft, watercraft, energy weapons, and the like. More specifically the present disclosure relates to integration of thermoelectric cooling into systems powered by gas turbine engines.

### BACKGROUND

Gas turbine engines are used to power aircraft, watercraft, energy weapons, power generators, and the like. The gas turbine engines generate mechanical energy often primarily used for propulsion or main power generation within the system. However, gas turbine engines can also be used to generate secondary electrical energy for powered electronics. Examples of such powered electronics include radars, imaging devices, communications equipment, navigation computers, etc.

Operation of gas turbine engines as well as powered electronics generates heat. The heat is often dissipated using various types of heat exchanger with fuel or oil as a fluid media pumped through the heat exchanger. As more powered electronics are added to systems, more heat must be dissipated. However, the addition of further heat exchanger systems presents challenges both in terms of cost and weight as well as in terms of heat capacity available in typical fuel and oil reservoirs.

### SUMMARY

The present disclosure may comprise one or more of the following features and combinations thereof.

A turbine-powered system according to the present disclosure may include a gas turbine engine and powered electronics. The gas turbine engine may be configured to accelerate air along an engine axis. The powered electronics may be mounted adjacent to the gas turbine engine and configured to generate heat during use.

In illustrated embodiments, the turbine powered system may also include a thermoelectric cooler. The thermoelectric cooler may be configured to selectively carry heat away from the powered electronics to the air moving through the gas turbine engine upon energizing of the thermoelectric cooler. The thermoelectric cooler may include a cooling plate coupled to the powered electronics, a heat sink mounted in a flow path of the air accelerated by the gas turbine engine, and alternating P- and N-type semiconductor pillars extending between the cooling plate and the heat sink.

In illustrated embodiments, the heat sink is integrated into aero surfaces of components included in the gas turbine engine that interface with the flow path of the air accelerated by the gas turbine engine.

In illustrated embodiments, the gas turbine engine is a turbofan engine includes an engine core, a bypass duct arranged around the engine core, and a turbofan driven by the engine core to accelerate air moving both into the engine core and through the bypass duct. The turbofan includes a fan case, a fan rotor with blades for accelerating the air, and a fan discharge splitter.

In illustrated embodiments, the fan discharge splitter includes an annular split ring that separates air moving from the turbofan to the engine core from air moving from the turbofan to the bypass duct, a number of core inlet vanes that extend radially-inward from the annular split ring to interact with and smooth the flow of air moving from the turbofan to the engine core, and outlet guide vanes that extend radially-outward from the annular split ring to interact with and smooth the flow of air moving from the turbofan to the bypass duct. In some such embodiments, the heat sink is integrated into the outlet guide vanes so that heat discharged from the thermoelectric cooler is passed to the flow of air moving from the turbofan to the bypass duct. The power electronics may be located radially outward of and axially aligned with the fan discharge splitter.

In illustrated embodiments, the heat sink extends along and forms part of a suction side aero surface included in the outlet guide vane. The outlet guide vane may be formed to include a recess along the suction side aero surface and the heat sink is arranged in the recess.

In illustrated embodiments, the turbofan includes a fan case and a fan rotor with blades for accelerating the air. The heat sink may be integrated into the fan case aft of the fan rotor so that heat discharged from the thermoelectric cooler is passed to a flow of air accelerated by the fan rotor. The power electronics may be located radially outward of and axially align with the fan case.

In illustrated embodiments, the fan case includes a metallic case and an acoustic panel located adjacent an aft end of the metallic case. The heat sink may be integrated into the acoustic panel.

In illustrated embodiments, the alternating P- and N-type semiconductor pillars are electrically coupled in series. In some such embodiments, the system further comprises an electrical power source and a controller configured to selectively energize the alternating P- and N-type semiconductor pillars to activate the thermoelectric cooler and transport heat from the cooling plate to the heat sink.

In illustrated embodiments, the electrical power source and the controller may be configured to activate the thermoelectric cooler based at least in part on information received from a temperature sensor indicative of a powered electronics temperature being greater than a threshold high temperature. The electrical power source and the controller may be configured to de-activate the thermoelectric cooler based at least in part on information received from the temperature sensor indicative of the powered electronics temperature being less than a threshold low temperature.

In illustrated embodiments, the electrical power source and the controller may be configured to activate the thermoelectric cooler based at least in part on information associated with power draw currently applied to the electrical power source indicative of power available for activation of the thermoelectric cooler in addition to other active electrical elements.

According to another aspect of the present disclosure, a method of cooling powered electronics in a turbine-powered system is taught. The method may include determining that cooling of the powered electronics is desired, and activating a thermoelectric cooler by supplying electrical power to the thermoelectric cooler.

In illustrated embodiments, the thermoelectric cooler includes a cooling plate coupled to the powered electronics, a heat sink integrated into aero surfaces of components included in a gas turbine engine associated with the system, and alternating P- and N-type semiconductor pillars extending between the cooling plate and the heat sink.

These and other features of the present disclosure will become more apparent from the following description of the illustrative embodiments.

### BRIEF DESCRIPTION OF THE DRAWINGS

FIG. 1 is a cross-sectional view of the gas turbine engine from showing an exemplary thermoelectric coolers integrated with turbofan outlet guide vanes as detailed in FIG. 2 and an exemplary thermoelectric cooler integrated with a fan case as detailed in FIGS. 5 and 6;

FIG. 2 is a detail view of a portion of the cross-sectional view in FIG. 1 showing a thermoelectric cooler for powered electronics, in which the thermoelectric cooler includes a heat sink integrated into a turbofan outlet guide vane so that heat discharged from the thermoelectric cooler is passed to a flow of air moving from a turbofan rotor toward a bypass duct around an engine core;

FIG. 3 is a perspective view of an outlet guide vane formed to include a recess along a suction side aero surface and the heat sink is arranged in the recess;

FIG. 3A is a sectional view of the exemplary outlet guide vane of FIG. 3 showing that recess formed in the suction side of the outlet guide vane and that the recess receives the heat sink;

FIG. 4 is a detail perspective view of a portion of the outlet guide vane and heat sink of FIG. 3 showing the heat sink in the recess;

FIG. 5 is a detail view of a portion of the cross-sectional view from FIG. 1 showing a thermoelectric cooler for powered electronics, in which the thermoelectric cooler includes a heat sink integrated into the fan case so that heat discharged from the thermoelectric cooler is passed to a flow of ambient air entering the engine; and

FIG. 6 is a perspective view of a portion of the fan case in FIG. 5 showing the fan case includes a metallic case and an acoustic panel located adjacent an aft end of the metallic case, and showing that the heat sink is integrated into the acoustic panel.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

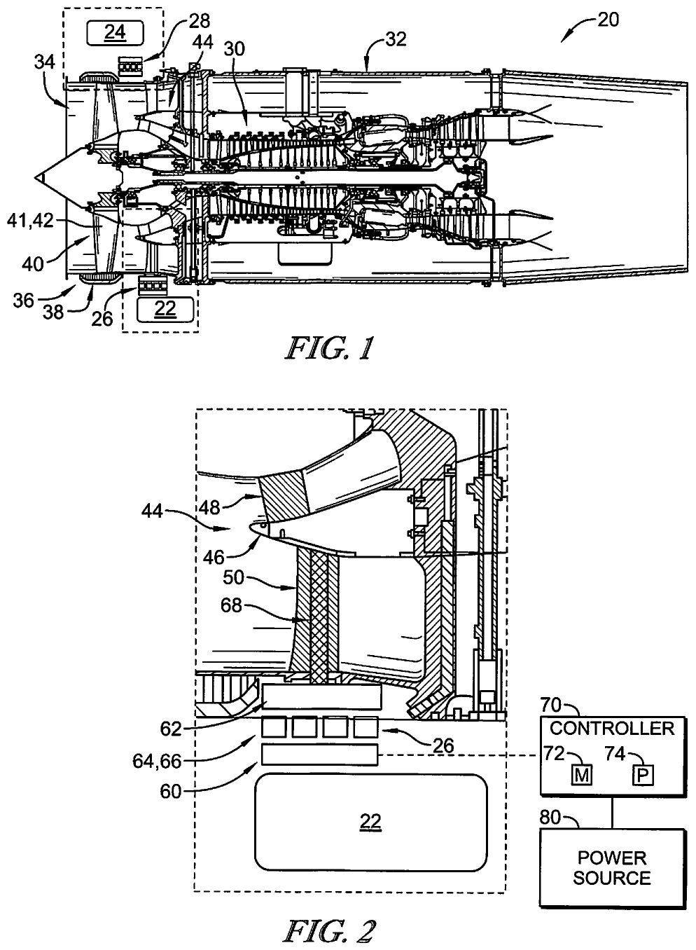

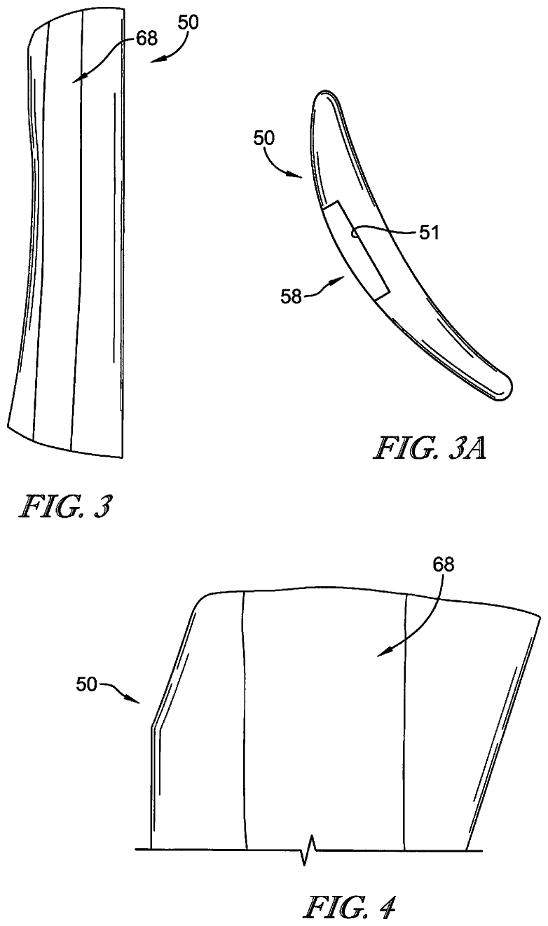

An illustrative aircraft system 10 includes a gas turbine engine 20 configured to provide thrust and power to the system 10 as suggested in FIG. 1. The aircraft system 10 is outfitted with a number of powered electronics 22, 24 that can include radars, imaging devices, communications equipment, navigation computers, etc. To dissipate excess heat developed by the powered electronics 22, 24, the aircraft system 10 also includes thermoelectric coolers 26, 28 as shown in FIGS. 1, 2, 5 and 6.

In the illustrative embodiment, parts of the thermoelectric coolers 22, 24 are integrated into the gas turbine engine 20 as shown in FIGS. 1, 2, and 5. In this way, heat from the powered electronics can be discharged into flows of air moving through the gas turbine engine 20, which are ultimately dumped away from the aircraft 10 to propel the aircraft 10 forward.

The thermoelectric coolers 26, 28 are configured to conduct heat from a heat absorption side to a heat rejection side when energized by an electric current. In this way, heat can be removed from the powered electronics 22, 24 on demand or based upon algorithms considering temperatures, power usage, power availability, and/or other factors.

Turning back to the gas turbine engine 20, the engine 20 illustratively includes an engine core 30, a bypass duct 32 arranged around the engine core 30, and a turbofan 34, as shown in FIG. 1. The turbofan 34 accelerates air moving both into the engine core 30 and through the bypass duct 32. In the engine core 32, fuel is mixed with compressed air and is combusted to, in turn, cause rotation of turbine rotor components. Leftover products of the combustion exiting the engine core 30 and accelerated air exiting the bypass duct 32 are mixed before being dumped out of the engine 20.

In the illustrative disclosure, the turbofan 34 receives ambient air entering the gas turbine engine 20. The turbofan 34 includes a fan case 38, a fan rotor 40 with blades 41, 42 for accelerating the air, and a fan discharge splitter 44 as shown in FIGS. 1 and 2.

The fan discharge splitter 44 includes an annular split ring 46, core vanes 48, and outlet guide vanes 50 as shown in FIGS. 1 and 2. The annular split ring 46 separates air moving from the turbofan 34 to the engine core 30 from air moving from the turbofan 34 to the bypass duct 32. The core inlet vanes 48 extend radially-inward from the annular split ring 46 to interact with and smooth the flow of air moving to the engine core 30. The outlet guide vanes 50 extend radially-outward from the annular split ring 46 to interact with and smooth the flow of air moving from the turbofan 34 to the bypass duct 32.

The fan case 38 includes a metallic case 52, blade retention ring 36, and an acoustic panel 54 located adjacent an aft end 55 of the metallic case 52 as shown in FIGS. 1 and 6. The blade retention ring 36 extends around the fan rotor 40 to block blades 41, 42 from release out of the fan case 38. The acoustic panel 54 is illustratively aft of the blade retention ring 36 and may include honeycomb cells or other structures suitable for dampening noise from the gas turbine engine 20.

As noted above, the powered electronics 22, 24 can be associated with radars, imaging devices, communications equipment, navigation computers, or any other electronic device that generates heat during operation. The powered electronics 22, 24 are illustratively mounted at a forward end of the engine 20 adjacent to, but radially outward of, the turbofan 34 as suggested in FIG. 1. However, it is contemplated that the powered electronics can be located in other positions along the engine 20 and/or even remote from the engine 20 with the thermoelectric coolers 26, 28 therebetween.

The thermoelectric coolers 26, 28, sometimes called Peltier cooler modules or thermoelectric heat pump, are solid state active heat pumps that transfer heat from one side of the cooler to the other. Each cooler 26, 28 has a hot side thermal conductor 60, a cold side thermal conductor 62, with alternating p & n-type semiconductor pillars 64, 66 placed therebetween. The p & n-type semiconductor pillars 64, 66 are thermally in parallel to each other and electrically in series and then joined with the thermally conductors 60, 62.

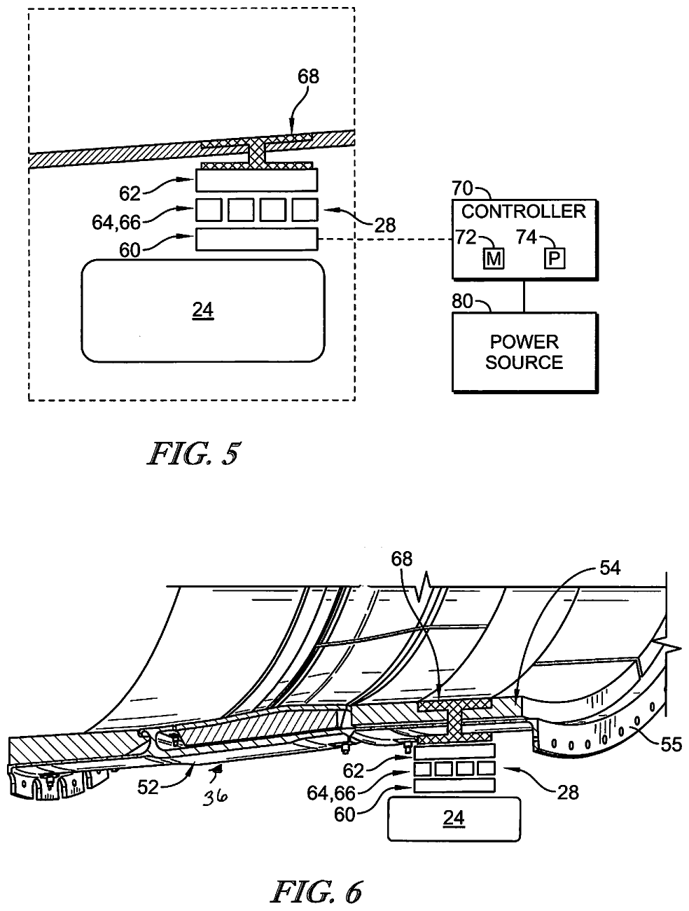

The thermoelectric coolers 26, 28 further include heat sinks 68 as suggested illustratively in FIGS. 2 and 5. The heat sinks 68 are integrated into the gas turbine engine 20 to interact with air moving through the gas paths of the engine 20.

More specifically, heat sink 68 of the illustrated thermoelectric cooler 26 is integrated with at least one of the outlet guide vanes 50 included in the fan discharge splitter 44 as shown in FIG. 4-6. In the illustrated embodiment, the heat sink 68 of the thermoelectric cooler 26 extends along and forms part of a suction side aero surface included in the outlet guide vane 50. To support this integration, the outlet guide vane 50 is formed to include a recess 51 along the suction side aero surface and the heat sink 68 is arranged in the recess 51. Of course, in other embodiments, the heat sink 68 could be incorporated along a pressure side aero surface, a leading edge, and/or a trailing edge of the outlet guide vane 50.

The heat sink 68 of the illustrated thermoelectric cooler 28 is integrated with the fan case 38 as shown in FIGS. 5 and 6. In the illustrated embodiment, the heat sink 68 of the cooler 28 is integrated into the acoustic panel 54 of the fan case 38 so that heat discharged from the thermoelectric cooler 28 is passed to a flow of air accelerated by the fan rotor.

Of course it is contemplated that heat sinks 68 can be integrated into various other components of the gas turbine engine 20. Preferably, such other heat sinks could be integrated at any location interfacing with relatively cool air, oil, or fuel moving through the engine 20. Also preferably, the heat sinks could be integrated with components near a radially outer location along the engine 20 so as to provide ready access to the hot side thermal conductor 60 of an associated thermoelectric cooler.

In illustrative embodiments, a controller 70 is provided as part of the system 10 as shown in FIG. 2. The controller 70 includes a memory 72 containing instructions/information and a processor 74 for executing instructions from the memory 72. The controller 70 is illustratively configured to energize the thermoelectric coolers 26, 28 based on one or more inputs. Inputs can include information from a user, from a temperature sensor, from a power generation and/or battery system 80, from a flight computer, or any other suitable input.

For example, the controller 70 may be configured to power the thermoelectric coolers based on information received from a temperature sensor indicative of a powered electronics temperature being greater than a threshold high temperature. The controller 70 may be configured to de-activate the thermoelectric cooler 26, 28 based at least in part on information received from the temperature sensor indicative of the powered electronics temperature being less than a threshold low temperature.

In another example, the controller 70 may be configured to activate the thermoelectric cooler 26, 28 based at least in part on information associated with power draw currently applied to the electrical power source 80 indicative of power available for activation of the thermoelectric cooler 26, 28 in addition to other active electrical elements. In this way, the coolers 26, 28 are used when power is available for the function.

Gas turbine engines and aircraft systems, like engine 20 and aircraft system 10, can generate a great deal of heat. Cooling electronics, oil, and fuel may be challenging if limited space in a bypass duct or similar as more systems are being added and more power is required to operate additional technologies. While air/fluid heat exchangers can reject heat from a working fluid, adding a cooling system for every component would be heavy.

Instead of additional bypass duct mounted heat exchangers, the present disclosure teaches utilization of thermoelectric cooling and aero surfaces in the fan system, exhaust system, and other systems to serve as heat sinks in the air. This can remove mechanical complexity of moving fluid or demanding more from existing systems when adding more cooling needs. External components sometimes mounted near the fan case aft flange or front frame or intermediate case giving proximity to the outlet guide vanes or struts or rear acoustic panels which may be used to cool heat sinks of Peltier coolers.

If systems that need cooling are mounted around the fan case or front frame or intermediate case or other suitable exterior engine component, then Peltier coolers could be used as long as there were effective heat sinks available. Three options spelled out here include the outlet guide vanes (OGVs), the front frame or intermediate case struts, and then rear panels of the fan case. These experience good flows of relatively cool air past them and which goes into the bypass flowpath instead of the core of the engine.

OGVs (outlet guide vanes) are typically composite—which have poor thermal conductivity, but a ribbon of high thermal conductivity material might be laid into the suction side or a thin layer could be bonded to it. The front frame intermediate case may be magnesium, titanium, or aluminum—with aluminum providing good conductivity. In some applications OGVs may be aluminum as well, which simplifies the configuration for thermoelectric cooling.

Rear acoustic panels are typically composites. But thermoelectric coolers could be embedded into such a panel and then installed into the case—if the panel might not be replaced by a cooler entirely. Similar is done in bypass ducts for surface air cooled oil coolers—but this would not require to incorporate high density oil or fuel, a pump, tubes/lines, nor potentially expose the component to be cooled to fluid leaks. Instead, the component could be mounted to a ceramic substrate or housing that is stacked on top of the rear panel and then the flow past the other end of the cooler removes heat with the help of electric current transporting it through the inner portions of the arrangement.

The disclosed approach to heat management would allow for cooling of components without expanding working fluid cooling systems or creating new cooling circuits. This could help electric powered turbofans which would not necessarily have a working fluid to cool with.

Other factors to consider is that there would be no moving parts, relatively small size and weight, high reliability, not affected by maneuvers, plus ability to spot cool locally and actively manage thermals. Increasing the heat rejection into the bypass flow path would have negligible impact to performance.

Heat management in line with this disclosure could cool electronics like FADEC (full authority digital engine controllers) without risk of fluids. It could also cool new technology incorporation such as tip injection flows which may be incorporated into such platforms.

Thermoelectric coolers work more effectively when pumping from warm to cooler ambient, as would be the case in the examples. It would consume power but could be used only as needed.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A turbine-powered system, the system comprising
a gas turbine engine configured to accelerate air along an engine axis,
powered electronics mounted adjacent to the gas turbine engine and configured to generate heat during use, and
a thermoelectric cooler configured to selectively carry heat away from the powered electronics to the air moving through the gas turbine engine upon energizing of the thermoelectric cooler, the thermoelectric cooler including a cooling plate coupled to the powered electronics, a heat sink mounted in a flow path of the air accelerated by the gas turbine engine, and alternating P- and N-type semiconductor pillars extending between the cooling plate and the heat sink,
wherein the heat sink is integrated into aero surfaces of components included in the gas turbine engine that interface with the flow path of the air accelerated by the gas turbine engine.

2. The system of claim 1, wherein the gas turbine engine is a turbofan engine including an engine core, a bypass duct arranged around the engine core, and a turbofan configured to accelerate air moving both into the engine core and through the bypass duct.

3. The system of claim 2, wherein the turbofan includes a fan case, a fan rotor with blades for accelerating the air, and a fan discharge splitter,
wherein the fan discharge splitter includes an annular split ring that separates air moving from the turbofan to the engine core from air moving from the turbofan to the bypass duct, a number of core inlet vanes that extend radially-inward from the annular split ring to interact with and smooth the flow of air moving from the turbofan to the engine core, and outlet guide vanes that extend radially-outward from the annular split ring to interact with and smooth the flow of air moving from the turbofan to the bypass duct, and
wherein the heat sink is integrated into the outlet guide vanes so that heat discharged from the thermoelectric cooler is passed to the flow of air moving from the turbofan to the bypass duct.

4. The system of claim 3, wherein the power electronics are located radially outward of and axially aligned with the fan discharge splitter.

5. The system of claim 3, wherein the heat sink extends along and forms part of an aero surface of the outlet guide vane.

6. The system of claim 5, wherein the outlet guide vane is formed to include a recess along the suction side aero surface and the heat sink is arranged in the recess.

7. The system of claim 2, wherein the turbofan includes a fan case and a fan rotor with blades for accelerating the air,
wherein the heat sink is integrated into the fan case aft of the fan rotor so that heat discharged from the thermoelectric cooler is passed to a flow of air accelerated by the fan rotor.

8. The system of claim 7, wherein the power electronics are located radially outward of and axially align with the fan case.

9. The system of claim 7, wherein the fan case includes a metallic case and an acoustic panel located adjacent an aft end of the metallic case.

10. The system of claim 9, wherein the heat sink is integrated into the acoustic panel.

11. The system of claim 1, wherein the alternating P- and N-type semiconductor pillars are electrically coupled in series, and the system further comprises an electrical power source and a controller configured to selectively energize the alternating P- and N-type semiconductor pillars to activate the thermoelectric cooler and transport heat from the cooling plate to the heat sink.

12. The system of claim 11, wherein the electrical power source and the controller are configured to activate the thermoelectric cooler based at least in part on information received from a temperature sensor indicative of a powered electronics temperature being greater than a threshold high temperature.

13. The system of claim 12, wherein the electrical power source and the controller are configured to de-activate the thermoelectric cooler based at least in part on information received from the temperature sensor indicative of the powered electronics temperature being less than a threshold low temperature.

14. The system of claim 11, wherein the electrical power source and the controller are configured to activate the thermoelectric cooler based at least in part on information associated with power draw currently applied to the electrical power source indicative of power available for activation of the thermoelectric cooler in addition to other active electrical elements.

15. A turbine-powered system, the system comprising
a gas turbine engine arranged along an engine reference axis,
powered electronics, and
a thermoelectric cooler including a cooling plate coupled to the powered electronics, a heat sink, and alternating P- and N-type semiconductor pillars extending between the cooling plate and the heat sink, wherein the heat sink is integrated into aero surfaces of components included in the gas turbine engine.

16. The system of claim 15, wherein the gas turbine engine is a turbofan engine including a fan, an engine core, and a bypass duct arranged around the engine core, and wherein the aero surface into which the heat sink is integrated is located radially outward of the engine core.

17. The system of claim 16, wherein the power electronics are located radially outward of and axially aligned with the heat sink.

18. The system of claim 15, wherein the aero surface into which the heat sink is integrated is an airfoil.

19. The system of claim 18, wherein the fan includes a fan rotor and a fan case, and wherein the aero surface into which the heat sink is integrated is included in the fan case.

20. A method of cooling powered electronics in a turbine-powered system, the method comprising
determining that cooling of the powered electronics is desired, and
activating a thermoelectric cooler by supplying electrical power to the thermoelectric cooler,
wherein the thermoelectric cooler includes a cooling plate coupled to the powered electronics, a heat sink integrated into aero surfaces of components included in a gas turbine engine associated with the system, and alternating P- and N-type semiconductor pillars extending between the cooling plate and the heat sink.
